(19) United States
(12) Patent Application Publication
(10) Pub. No.: US 2010/0017032 A1
(43) Pub. Date: Jan. 21, 2010

(54) DEVICE FOR CONTROLLING A ROBOT

(75) Inventors: Fan DAI, Zwingenberg (DE); Anke Frohberger, Heidelberg (DE); Björn Matthias, Bad Schönborn (DE); Joachim Unger, Friedberg (DE)

Correspondence Address: BUCHANAN, INGERSOLL & ROONEY PC, POST OFFICE BOX 1404, ALEXANDRIA, VA, 22313-1404, US

(73) Assignee: ABB TECHNOLOGY AG, Zurich (CH)

(21) Appl. No.: 12/545,302

(22) Filed: Aug. 21, 2009

Related U.S. Application Data
(63) Continuation of application No. PCT/EP2008/000278, filed on Jan. 16, 2008.

(30) Foreign Application Priority Data
Feb. 23, 2007 (DE) 10 2007 008 903.3

(51) Int. Cl. G05B 19/04; B25J 19/04

(52) U.S. Cl. 700/251; 700/259

(57) ABSTRACT

A device is disclosed for controlling a robot, with a robot control unit, and with a robot sensor such as a digital camera, which can be fitted on the robot and whose output signals can be supplied to an image recording unit. The output signals from the image recording unit connected to the camera can be supplied to an image processing device which is connected to the image recording unit. A coordinate transformation device is provided, in which the signals originating from the image processing unit and the robot control unit are processed and transformed into robot control signals, and the signals can be supplied back to the robot control unit.

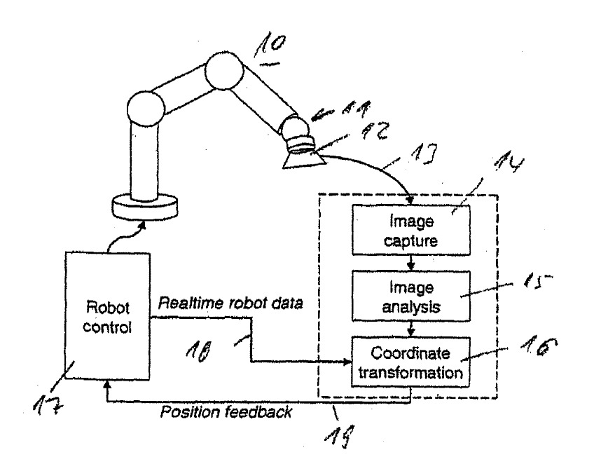

### RELATED APPLICATIONS

This application claims priority as a continuation application under 35 U.S.C. §120 to PCT/EP2008/000278, which was filed as an International Application on Jan. 16, 2008 designating the U.S., and which claims priority to German Application 10 2007 008 903.3 filed in Germany on Feb. 23, 2007. The entire contents of these applications are hereby incorporated by reference in their entireties.

### FIELD

The disclosure relates to a device for controlling a robot.

### BACKGROUND INFORMATION

Robots are used for machining workpieces, for example, for machining motor vehicle bodywork, such as for welding or painting the bodywork. For this purpose, it is desirable to prescribe a sequence of movement for the robot, i.e. to input a desired sequence of movement into a robot control unit, so that the robot arm or the workpiece mounted thereon machines the bodywork in the prescribed manner.

During machining, it may occur that the position and/or shape of the workpiece do not correspond precisely to the position and/or shape of the workpiece which are intended to be prescribed in theory, e.g. it may be that edges of two pieces of sheet metal which are to be welded together are not situated exactly in the prescribed line but rather are situated obliquely with respect thereto, or both edges may be at an angle with respect to one another.

So that such inaccuracies in shape and/or position do not adversely affect the result of machining, a sensor system can be used which captures the actual machining circumstances and actuates the robot accordingly.

The positional accuracy of a robot per se is sufficient, which means that the tolerances of the robot are rather negligible. On the other hand, it may still occur in rare cases that the positional accuracy is not optimum. It is possible to capture and correct this—in the same way—using sensors described above. Nevertheless, attention is often directed at inaccuracies and discrepancies in the position and/or shape of a workpiece which is to be machined.

One method involves using a digital camera to record the actual position and/or shape of the workpiece and to capture and process the signals in an image capture and image processing device and to supply these signals to the robot control unit, so that the robot can be actuated following comparison of the actual values with the setpoint values for the movement.

This involves knowledge of the position of the camera. If the camera is fitted to the robot, its position in space will change in accordance with the movement of the robot, which involves knowledge regarding the current tool center. The control method in known devices is performed as follows:
The robot moves a particular distance and stops, with an image being recorded which is processed while the robot advances to the next image capture point. Discrete points can be considered during control of a robot and the application cycle time cannot be reduced further.

Instead of a digital camera, it is also possible to use other sensors which can be used to perform the cited measurements. Again only discrete points are captured during control of a robot, as a result of which it is also not possible to reduce the application cycle time further.

### SUMMARY

A device is disclosed for controlling a robot. Exemplary embodiments include a robot control unit; at least one signal-generating robot sensor for supplying output signals to a signal capture unit connected to a signal processing device; and a coordinate transformation device for processing signals from the signal processing device and from the robot control unit to form robot control signals for the robot control unit to control robot movement, wherein the signals supplied to the coordinate transformation unit by the robot control unit are realtime robot data signals.

### BRIEF DESCRIPTION OF THE DRAWINGS

The disclosure and further advantageous refinements will be explained and described in more detail with reference to the drawing, which shows an exemplary embodiment of the disclosure and in which:

the single FIGURE shows a schematic flowchart illustration of an exemplary device according to the disclosure.

### DETAILED DESCRIPTION

A device for controlling a robot is disclosed which can, for example, reduce cycle time.

An exemplary device is disclosed herein for controlling a robot, and includes a robot control unit, and at least one signal-generating robot sensor which can be fitted to a robot and whose output signals can be supplied to a signal capture unit. Output signals from the signal capture unit connected to the at least one sensor can be supplied to a signal processing device which is connected to the signal capture unit. A coordinate transformation device is provided in which the signals coming from the signal image processing device and the robot control unit are processed to form robot control signals which in turn can be supplied to the robot control unit for controlling robot movement, wherein the signals supplied to the coordinate transformation unit by the robot control unit can be realtime robot data signals.

In accordance with exemplary embodiments, movement data for the robot or movement data for a tool center are supplied to the signal capture unit and/or the image processing device in real time.

An exemplary device for controlling a robot can be formed from the robot control unit (e.g., a processor). At least one sensor, such as a camera, can be fitted to the robot, whose output signals can be supplied to an image processing unit which can be configured with one or more processors. The image processing unit can include an image capture unit (e.g., processor and/or processor module), wherein the output signals from the image capture unit connected to the camera can be supplied to an image processing unit (e.g., separate processor and/or processing module) connected to the image capture device. A coordinate transformation device (e.g., separate processor and/or processing module) processes signals coming from the image processing device and also from the robot control unit to form robot control signals which are in turn supplied to the robot control unit for the purpose of controlling the robot movement or a tool, wherein the signals supplied from the robot control unit to the coordinate transformation unit via a signal line are realtime robot data signals.

The robot control unit, with a realtime robot data interface, can generate anticipated and optionally current data for a tool center of the robot with corresponding time markers. These data can be calculated within the robot control unit with a high level of accuracy and at high update rates. The camera can be held by the robot and connected to the image processing unit, which can include three subunits:
image capture unit
image processing device
coordinate transformation device or unit.

The image processing device can, for example, be in the form of a processor and/or computer program product, and/or can be located on an external computer or inside the robot control unit, or may be part of the camera. The image processing device an communicate with robot control software modules via the aforementioned realtime robot data interface.

If the image processing device or unit is not part of the robot unit, the system times (e.g., clocking signals) for the robot unit and possibly external computer unit then can be synchronized; the synchronization can also be based on a common time reference. This can be done using known methods.

The image capture may be triggered or untriggered. In the former case, when the image capture is performed in triggered fashion, a trigger signal (either digital or analog) can be received at each instant in the image capture, the trigger signal being able to be generated by the robot or other desired apparatus. If the image capture is effected in untriggered fashion, the image processing device can, for example, perform the image processing during each internal process loop.

During the image capture, the current time can be recorded and associated with the image data and all subsequent data associated with the image.

The signals transmitted from the camera to the image capture unit can be associated with one another in line with the coordinate system of the camera, the image coordinate system being an exemplary two-dimensional coordinate system. For example, depending on the arrangement of a camera with an optimal distance measurement or two cameras associated with one another in a suitable manner, a three-axis, spatial coordinate system can be used. If a plurality of cameras is provided, the images can be set up in a common overall coordinate system, so that it is a relatively simple matter to determine where the object is located.

The two-dimensional or three-dimensional data generated in the image processing device can be converted in the coordinate transformation device into coordinates which are associated with the robot, so that the robot control unit can record the output signals from the coordinate transformation device and, if desired, process them further. Coordinate transformations can be performed using known methods that need not be described in more detail at this juncture.

In accordance with exemplary features, the position of the camera at the instant of image capture can be calculated by interpolation by using a predicted robot tool center data. Optionally, the current robot tool center data can be used in order to additionally obtain an improved approximation.

These situations or positions can be used by a process control unit or for the robot control unit for the further machining, i.e. for controlling the robot.

To capture the position and/or shape, for example of the workpiece which is being machined by the robot, it is possible to use a camera with a distance sensor, for example, which allows the position of the object in space to be determined. Furthermore, it is also possible to configure the camera as two cameras which allow three-dimensional image capture. It is also possible to include or attach other sensors with distance measuring devices which can be used to, for example, establish the position and/or shape of the workpiece which is to be machined in space.

Referring to the Figure, an exemplary embodiment is illustrated wherein a robot 10 carries a digital camera 12 at the free end of its moving arm 11, the output signals from said camera being supplied to a signal capture unit represented as image capture unit 14 via a signal line 13. The output signals from the image capture unit 14 are supplied to a signal processing device represented as image processing device 15, the output signals from which are forwarded to a coordinate transformation unit 16.

The robot 10 is controlled by a robot control unit 17 which can operate in known fashion except that it can transmit realtime robot data, such as robot movement data of any or all movable portions of the robot, and/or movement data of a tool center of the robot to the coordinate transformation unit 16 via a first signal line 18. The signals which are supplied to the coordinate transformation unit 16 by the image processing device 15 and by the robot controller 17 are processed in said coordinate transformation unit 16 using known coordinate transformation techniques to transform control information into coordinates which can be read or interpreted by the robot and are supplied to the robot control unit 17 via a second signal line 19, as a result of which a closed, realtime control loop for the robot (and/or tool center) controller is produced.

The signal lines 13, 18 and 19 may be formed by connecting lines; it is also possible to use bus links or internal data links, or any other suitable interface.

In this case, the signal lines indicate that particular signals are transmitted from an output of one unit to the input of the next unit.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

10 robot
11 moving arm
12 digital camera
signal line
image capture unit
image processing device
coordinate transformation device or unit
robot control unit
first signal line
second signal line

What is claimed is:

1. A device for controlling a robot, comprising:
a robot control unit;
at least one signal-generating robot sensor for supplying output signals to a signal capture unit connected to a signal processing device; and
a coordinate transformation device for processing signals from the signal processing device and from the robot control unit to form robot control signals for the robot control unit to control robot movement, wherein the signals supplied to the coordinate transformation unit by the robot control unit are realtime robot data signals.

2. The device as claimed in claim 1, wherein the robot sensor is a digital camera, the signal capture unit is an image capture unit, and the signal processing device is an image processing device.

3. The device as claimed in claim 2, wherein the digital camera includes a distance measuring element.
